(19) United States
(12) Patent Application Publication
(10) Pub. No.: US 2025/0097770 A1
(43) Pub. Date: Mar. 20, 2025

(54) UPDATES FOR UNASSOCIATED STATIONS

(71) Applicant: QUALCOMM Incorporated, San Diego, CA (US)

(72) Inventors: Yanjun SUN, San Diego, CA (US); Alireza RAISSINIA, Monte Sereno, CA (US); Abhishek Pramod PATIL, San Diego, CA (US); Gaurang NAIK, San Diego, CA (US); Sai Yiu Duncan HO, San Diego, CA (US); Abdel Karim AJAMI, San Diego, CA (US); Alfred ASTERJADHI, San Diego, CA (US); George CHERIAN, San Diego, CA (US)

(21) Appl. No.: 18/471,275

(22) Filed: Sep. 20, 2023

(51) Int. Cl. H04W 28/086; H04W 52/02; H04W 68/00

(52) U.S. Cl. CPC H04W 28/0861; H04W 52/0203; H04W 68/005

(57) ABSTRACT

Aspects of the present disclosure provide mechanisms for conveying (critical) updates to a corresponding STA that is in an unassociated state. In some cases, a network entity may obtain an update during a communication session, such as a sensing measurement session. The network entity may then output a notification of the update to another wireless device. The network entity may also output the actual update itself.

### TECHNICAL FIELD

This disclosure relates generally to wireless communication, and more specifically, to signaling updates for stations (STAs) that are in an unassociated state.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented at a first wireless node for wireless communication. The first wireless node includes at least one memory including instructions; and one or more processors configured, individually or in any combination, to execute the instructions and cause the first wireless node to: obtain, during a current communication session, an update associated with at least one parameter and output, for transmission, a notification of the update to a second wireless node that is in an unassociated state.

Another innovative aspect of the subject matter described in this disclosure can be implemented at a second wireless node for wireless communication. The second wireless node includes at least one memory including instructions; and one or more processors configured, individually or in any combination, to execute the instructions and cause the first wireless node to: obtain, while the second wireless node is in an unassociated state during a current communication session, a notification from a first wireless node indicating an update associated with at least one parameter and obtain the update.

Another innovative aspect of the subject matter described in this disclosure can be implemented as a method for wireless communications at a first wireless node. The method generally includes obtaining, during a current communication session, an update associated with at least one parameter and outputting, for transmission, a notification of the update to a second wireless node that is in an unassociated state.

Another innovative aspect of the subject matter described in this disclosure can be implemented as a method for wireless communications at a first wireless node. The method generally includes obtaining, while the second wireless node is in an unassociated state during a current communication session, a notification from a first wireless node indicating an update associated with at least one parameter and obtaining the update.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a pictorial diagram of another example wireless communication network.

FIG. 5 shows an example PPDU usable for communications between a wireless AP and one or more STAs.

FIG. 6 shows a graphical representation of WLAN sensing.

FIG. 7 shows an example sensing procedure.

FIG. 8 shows an example call flow diagram, in accordance with aspects of the present disclosure.

FIG. 9 shows an example timing diagram for a signaling mechanism for conveying updates to unassociated STAs, in accordance with aspects of the present disclosure.

FIG. 10 shows an example timing diagram for a signaling mechanism for conveying updates to unassociated STAs, in accordance with aspects of the present disclosure.

FIG. 11 shows an example timing diagram for a signaling mechanism for conveying updates to unassociated STAs, in accordance with aspects of the present disclosure.

FIG. 12 shows an example timing diagram for a signaling mechanism for conveying updates to unassociated STAs, in accordance with aspects of the present disclosure.

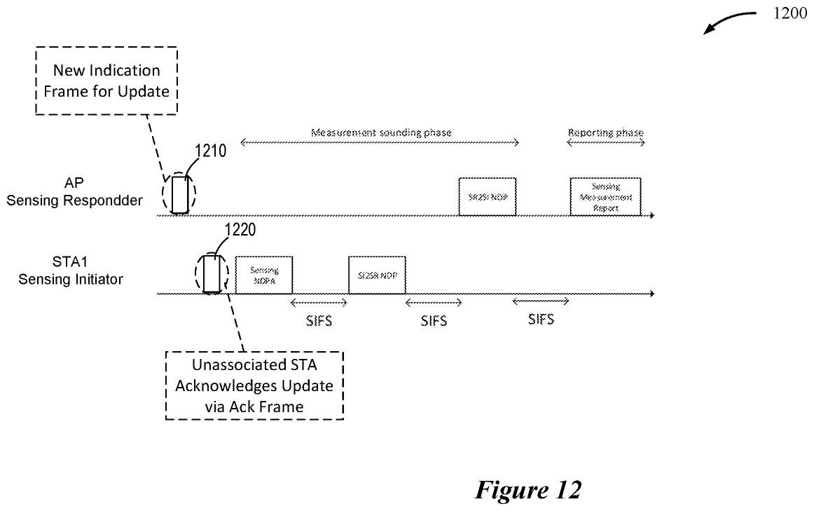

FIG. 13 shows a flowchart illustrating an example process performable by or at an access point that supports a mechanism for signaling updates to an unassociated station.

FIG. 14 shows a flowchart illustrating an example process performable by or at a wireless station that supports a mechanism for signaling updates to an unassociated station.

FIG. 15 shows a block diagram of an example wireless communication device that supports a mechanism for signaling updates to an unassociated station.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

In wireless systems, a wireless station (STA) typically goes through four states of connectivity during a communications system. In a first state, the STA is unauthenticated and unassociated and has no type of connection to the network, but may be looking for a network to join. After performing a successful authentication, the STA may leave the first station and transition to a second state in which the UE is authenticated but unassociated.

STAs in an unassociated state are limited in their interaction with a network. Certain networks may allow an unassociated STA to participate in certain types of communications. For example, certain networks (e.g., 802.11bf and 802.11az) may allow unassociated STAs to exchanges frames with an AP. For example, such networks may allow an unassociated STA to participate in sensing operations.

WLAN sensing generally refers to a technology that uses Wi-Fi signals to perform sensing tasks, by exploiting prevalent Wi-Fi infrastructures and ubiquitous Wi-Fi signals over surrounding environments. Wi-Fi signals can bounce, penetrate, and bend on the surface of objects during their propagation. Surrounding environments may be sensed by processing the received Wi-Fi signals, for example, allowing obstructions to be detected and target movements to be tracked.

While certain systems allow unassociated STAs to communication, there are certain challenges presented when communicating with unassociated STAs. For example, in an unassociated state, a STA may not receive updates to operating parameters because unassociated stations typically do not monitor for beacon frames that contain the updates, some of which may be considered critical. Examples of such updates include Transmit Power Envelop (TPE) updates and spatial stream change updates. Without a procedure for an unassociated STA to monitor for such critical updates, an unassociated STA may violate certain network rules.

Aspects of the present disclosure provide mechanisms for conveying (critical) updates to a corresponding STA that is in an unassociated state. In some cases, a network entity may obtain an update during a communication session, such as a sensing measurement session. The network entity may then output a notification of the update to another wireless device. The network entity may also output the actual update itself.

Thus, aspects of the present disclosure may allow updates to be applied, even by STAs that are as of yet unassociated with a network. As a result of the mechanisms proposed herein, a STA trying to access the network may be able to apply the updates, which may help reduce latency and improve overall system performance.

### Example Wireless Communication Network

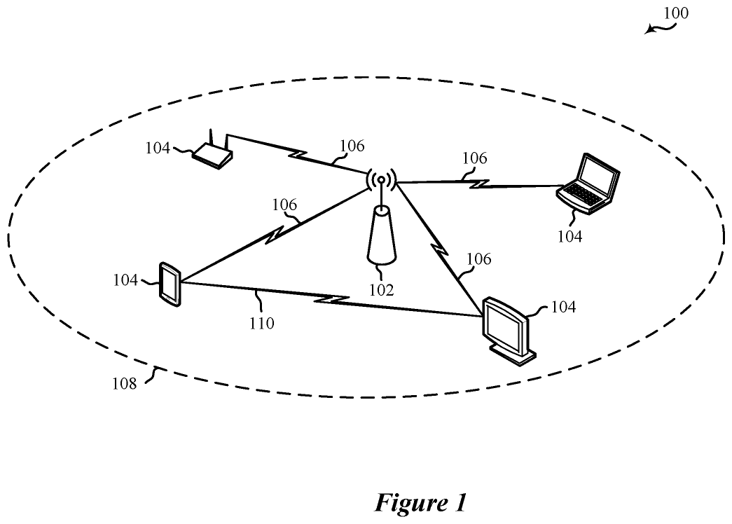

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless access point (AP) 102 and multiple wireless stations (STAs) 104. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHz, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload

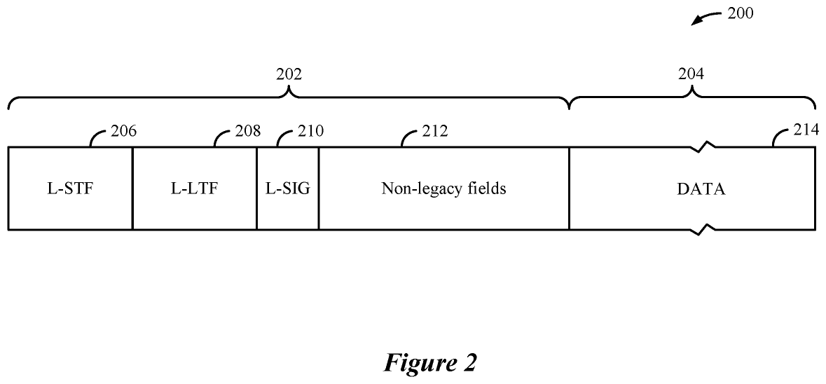

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

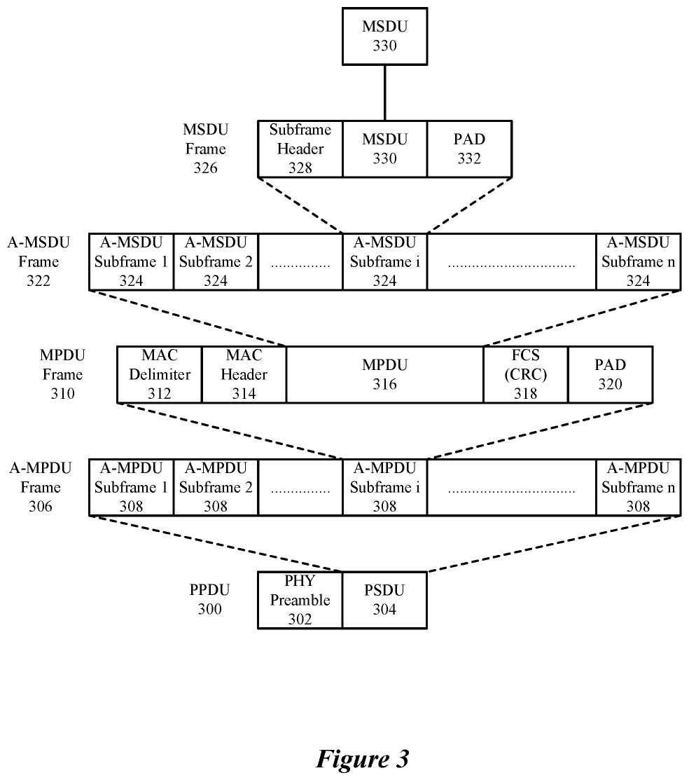

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 316. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP, The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices or nodes as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

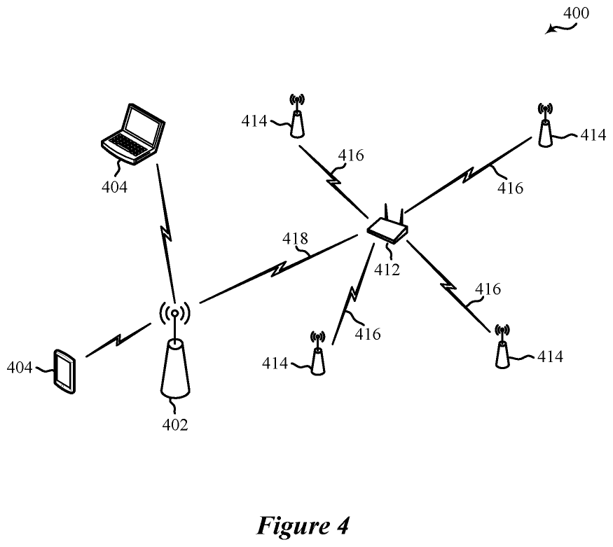

FIG. 4 shows a pictorial diagram of another example wireless communication network 400. According to some aspects, the wireless communication network 400 can be an example of a mesh network, an IoT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

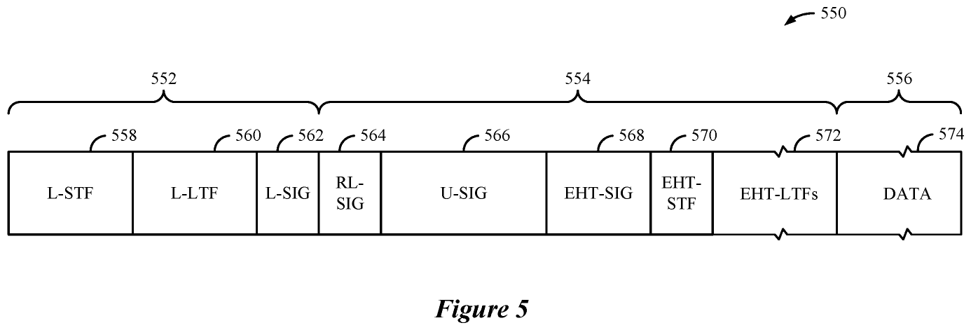

FIG. 5 shows an example PPDU 550 usable for communications between a wireless AP and one or more STAs. As shown, a legacy portion 552 of a preamble of the PPDU 550 includes an L-STF 558, an L-LTF 560, and an L-SIG 562. The non-legacy portion 554 of the preamble includes a repetition of L-SIG (RL-SIG) 564 and multiple wireless communication protocol version-dependent signal fields after RL-SIG 564. For example, the non-legacy portion 554 may include a universal signal field 566 (referred to herein as “U-SIG 566”) and an EHT signal field 568 (referred to herein as “EHT-SIG 568”). The presence of RL-SIG 564 and U-SIG 566 may indicate to EHT-or later version-compliant STAs 104 that the PPDU 550 is an EHT PPDU or a PPDU conforming to any later (post-EHT) version of a new wireless communication protocol conforming to a future IEEE 802.11 wireless communication protocol standard. One or both of U-SIG 566 and EHT-SIG 568 may be structured as, and carry version-dependent information for, other wireless communication protocol versions associated with amendments to the IEEE family of standards beyond EHT. For example, U-SIG 566 may be used by a receiving device to interpret bits in one or more of EHT-SIG 568 or the data field 574. Like L-STF 558, L-LTF 560, and L-SIG 562, the information in U-SIG 566 and EHT-SIG 568 may be duplicated and transmitted in each of the component 20 MHz channels in instances involving the use of a bonded channel.

The non-legacy portion 554 further includes an additional short training field 570 (referred to herein as “EHT-STF 570,” although it may be structured as, and carry version-dependent information for, other wireless communication protocol versions beyond EHT) and one or more additional long training fields 572 (referred to herein as “EHT-LTFs 572,” although they may be structured as, and carry version-dependent information for, other wireless communication protocol versions beyond EHT). EHT-STF 570 may be used for timing and frequency tracking and AGC, and EHT-LTF 572 may be used for more refined channel estimation.

EHT-SIG 568 may be used by an AP to identify and inform one or multiple STAs 104 that the AP has scheduled UL or DL resources for them. EHT-SIG 568 may be decoded by each compatible STA 104 served by the AP 102. EHT-SIG 568 may generally be used by a receiving device to interpret bits in the data field 574. For example, EHT-SIG 568 may include RU allocation information, spatial stream configuration information, and per-user (for example, STA-specific) signaling information. Each EHT-SIG 568 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 574.

### Overview of WLAN Sensing

WLAN sensing generally refers to a technology that uses Wi-Fi signals to perform sensing tasks, by exploiting prevalent Wi-Fi infrastructures and ubiquitous Wi-Fi signals over surrounding environments. Wi-Fi signals can bounce, penetrate, and bend on the surface of objects during their propagation. Surrounding environments may be sensed by processing the received Wi-Fi signals, for example, allowing obstructions to be detected and target movements to be tracked.

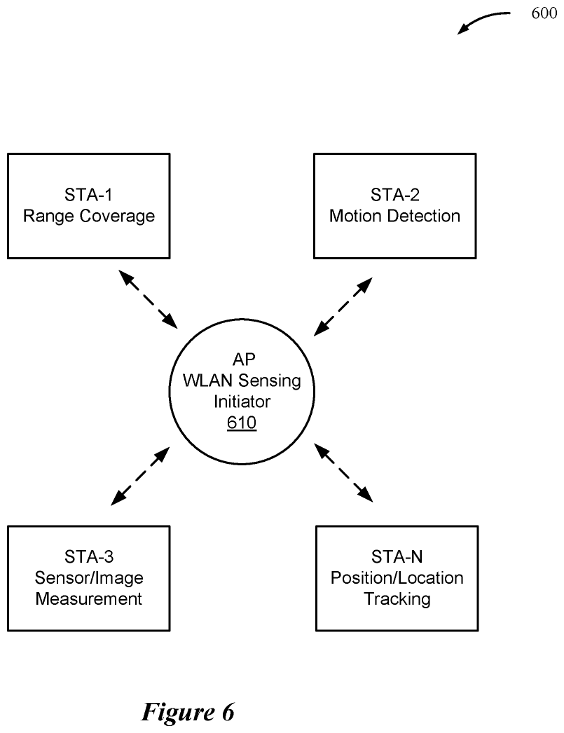

FIG. 6 shows a graphical representation of a WLAN sensing system 600, in which an AP 610 acts as a WLAN sensing initiator. The AP participates in WLAN sensing with various stations (STA-1 to STA N) As illustrated, WLAN sensing may be utilized for various purposes, such as range coverage (determining a maximum allowable distance from a sensing STA to a target, such that the target can be successfully detected), motion detection, sensor/image measurement, and position/location tracking.

IEEE 802.11bf defines a sensing procedure and a sensing session. A sensing procedure allows a STA to perform WLAN sensing and obtain measurement results. A sensing session is an agreement between a sensing initiator and a sensing responder to participate in the sensing procedure. In this case, a sensing initiator and sensing responder are defined depending on which STA initiates a WLAN sensing procedure. A sensing initiator generally refers to a STA that initiates a sensing procedure. A sensing responder generally refers to a STA that participates in a sensing procedure initiated by a sensing initiator. Both the sensing initiator and sensing responder can be an AP or a non-AP STA (i.e., client).

Depending on which device transmits a WLAN signal (e.g., a PPDU) used to obtain measurements, a STA may serve a role as a sensing transmitter or a sensing receiver. A sensing transmitter generally refers to a STA that transmits PPDUs used for sensing measurements in a sensing procedure. A sensing receiver generally refers to a STA that receives PPDUs sent by a sensing transmitter and performs.

A sensing initiator can be either a sensing transmitter or a sensing receiver during a sensing procedure. A sensing responder is similar to the sensing initiator and can be either the sensing transmitter, the sensing receiver or both. A STA can assume multiple roles in one sensing procedure.

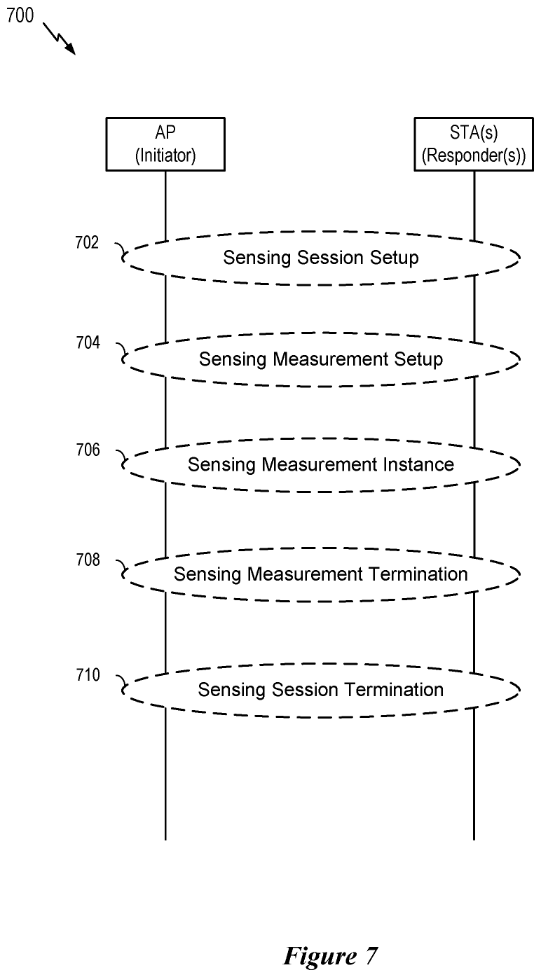

FIG. 7 shows an example call flow diagram 700 for a WLAN sensing procedure, which may be in-line with the IEEE 802.11bf WLAN sensing procedure. As illustrated, a WLAN sensing procedure typically contains five phases: sensing session setup 702, sensing measurement setup 704, sensing measurement instance 706, sensing measurement termination 708, and sensing session termination 710.

In the sensing session setup 702, the sensing initiator establishes a sensing session with the sensing responder(s), and the sensing-related capabilities are exchanged between them at this stage. Sensing measurement setup 704 allows for a sensing initiator and a sensing responder to exchange and agree on operational attributes associated with a sensing measurement instance, which includes the role of the STA, the type of measurement report, and other operational parameters.

In the sensing measurement instance 706, sensing measurements are performed. Measurement Instance IDs may be used to identify different sensing measurement instances. In the sensing measurement termination 708, the corresponding sensing measurement setups are terminated. The sensing initiator and the sensing responder release the allocated resources to store the sensing measurement setup. In the sensing session termination 710, STAs stop performing measurements and terminate the sensing session.

### Signaling Updates for Unassociated Stations

As noted above, under certain conditions, some wireless stations may not be able to receive updates to operating parameters that may be considered critical. For example, in an unassociated state, a STA may not receive updates to operating parameters because unassociated stations typically do not monitor for beacon frames that contain the updates. Examples of such updates include Transmit Power Envelop (TPE) updates, puncturing pattern updates, and spatial stream change updates. Without a procedure for an unassociated STA to monitor for such critical updates, an unassociated STA may violate certain network or regulatory rules.

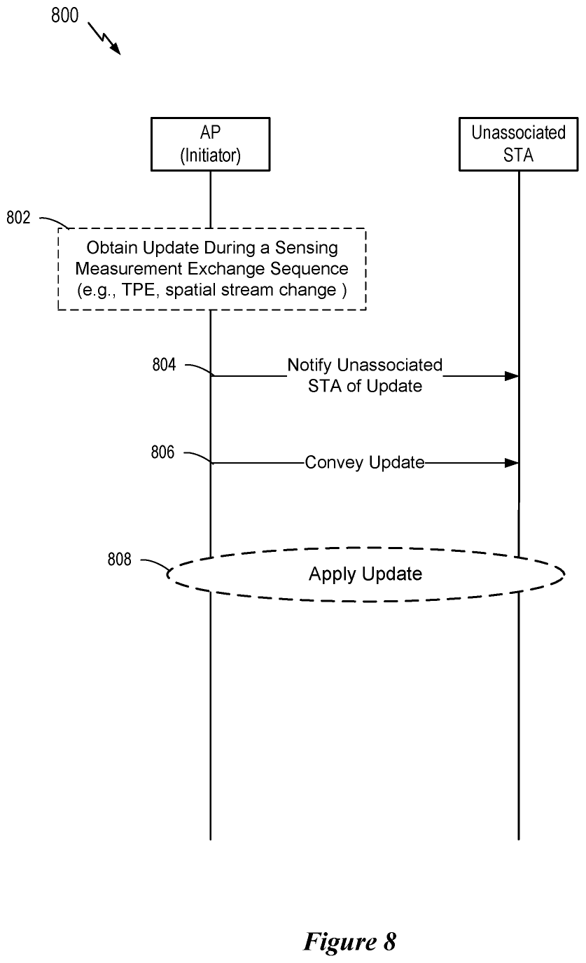

Signaling mechanisms for updates to a wireless node (e.g., an unassociated STA) may be understood with reference to the call flow diagram 800 of FIG. 8. In the illustrated example, an AP is a sensing initiator and an unassociated STA is a sensing responder.

The AP may obtain, during a current communication session (e.g., a sensing measurement session), an update associated with at least one operating parameter. The update may be obtained from another entity, may be obtained from a server, or may be obtained internally from memory or an algorithm (e.g., the AP may determine/select/cause the update). In some cases, as illustrated at 802, the AP may obtain the update during a sensing measurement exchange sequence. For example, the update associated with the at least one operating parameter may be a TPE update or spatial stream change.

As illustrated at 804, the AP may notify the unassociated STA of the update. As illustrated at 806, the AP may convey the update. In some cases, as will be described in greater detail below, the notification and update may be signaled together. This may allow the AP and STA to both apply the update, as indicated at 808, even though the STA is in an unassociated state. Allowing the AP and STA to be in agreement on applying the update may result in increased performance (e.g., and avoid violating network and/or regulatory rules).

Various options are proposed herein for signaling updates to unassociated stations. For example, according to a first option, an existing communication session may be terminated (e.g., with a Sensing Measurement Termination frame) and re-established with the update included in the frame(s) for session negotiation (e.g., a Sensing Measurement Request frame or a Sensing Measurement Response frame). This option may be useful, for example, if the AP has no other efficient way to notify an unassociated STA about a critical update. By terminating the session with the STA, the STA can be updated with the latest info (e.g., TPE, spatial stream change) during reestablishment of the session.

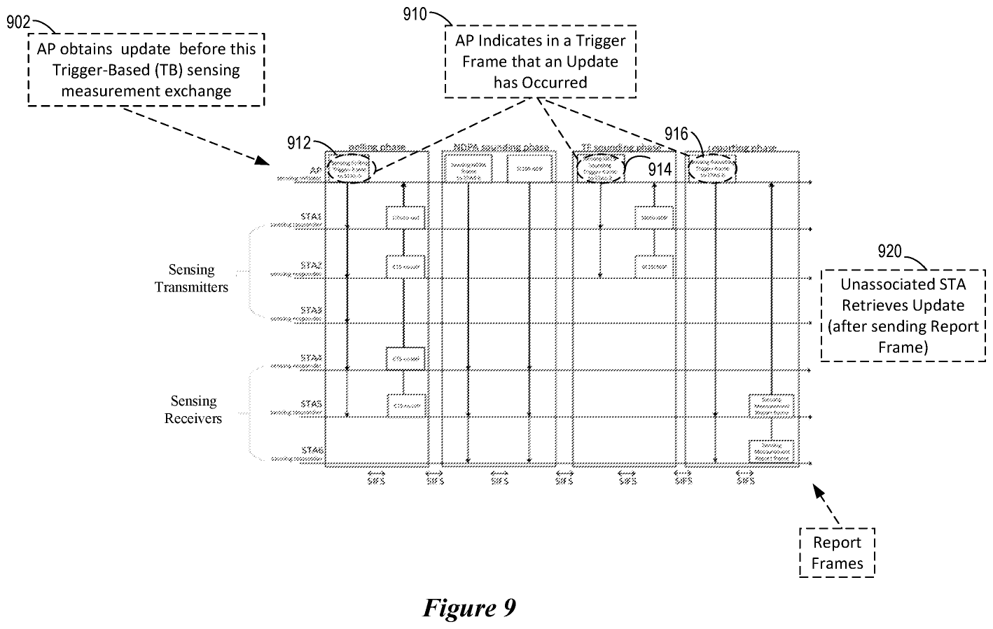

As illustrated in FIG. 9, according to a second option, an existing session may be updated during a measurement sensing exchange sequence. This option may apply to both a trigger based (TB) sensing measurement exchange and a non-TB sensing measurement exchange.

The example illustrated in FIG. 9 assumes, as indicated at 902, that the AP obtains an update before a TB sensing measurement exchange. For example, the example may assume a critical update (e.g., TPE) happens just before the TB sensing measurement exchange.

As indicated at 910, the AP may provide a notification of the update via an indication provide in a trigger frame (TF) that an update has occurred. For example, the notification may be provided via a sensing polling TF 912, a sensing sounding TF 914, and/or a sensing reporting TF 912. For example, the AP may indicate in any of these TFs that a critical update has occurred. The indication may be provided using one or multiple bits, such as a reserved bit in a Common Info field, a User Info field, or a Trigger Dependent field. If multiple bits are used, these bits could be in a BSS Parameter Change Count field, as in Beacon frame. For example, the AP may send the indication using the Comeback subfield in the User Info field.

In the illustrated example, as indicated at 920, based on the notification (e.g., in TF 916) an unassociated STA (STA 5), may retrieve the update(s) after the measurement exchange (e.g., after report frames).

The STA may retrieve the update based on one or more different approaches. For example, according to a first approach, the unassociated STA may monitor for Beacon frame(s) from the AP to retrieve the critical update (e.g., the latest TPE). In the second approach, the STA may send a Probe request so that the AP can use a Probe response for an update and confirm the reception with an acknowledgment (ACK).

According to a third approach, the unassociated STA may send a query frame to the AP, such as a sensing measurement query frame. In response, the AP may transmit a frame that contains the critical update. This response frame may be, for example, a sensing measurement request frame, a sensing measurement response frame, or a sensing measurement termination frame extended to include the parameters associated with the critical update. For example, the critical update can be included as an element or sub-element. In some cases, if the sensing measurement termination frame is used, one of the (previously) reserved bits can be used to indicate that the intention of the frame is to update the current session instead of terminating it. The parameters(s) associated critical update (e.g., the latest TPE) may also be included.

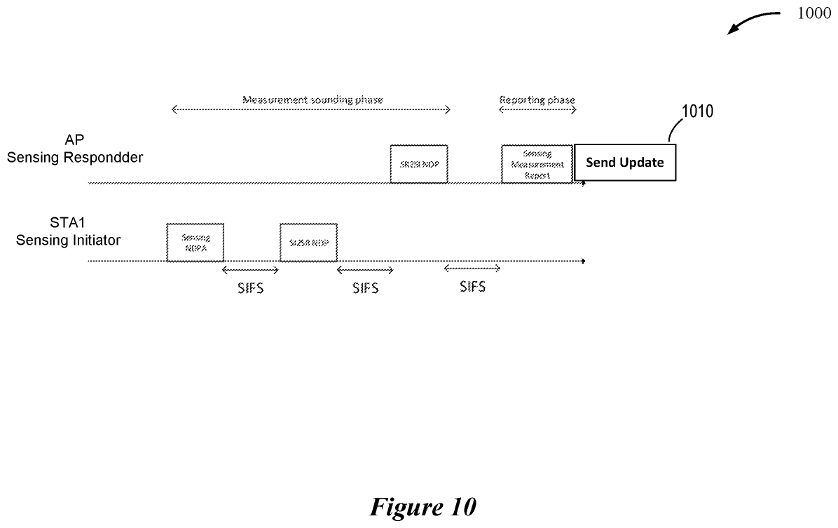

As illustrated in the timing diagram 1000 of FIG. 10, for a non-TB sensing measurement exchange, an AP may send a critical update 1010 together with a sensing measurement report frame.

In some cases, the update may be included in the Sensing Measurement Report frame itself (e.g., as an element or sub-element). Two versions of such a report frame may be defined: an Action ACK or Action no-ACK frame (e.g. using the category/action field). If the critical update is included, the ACK version may be used to ensure the STA receives the update. Otherwise, the non-ACK version may be used.

In some cases, the update may be included in a separate frame that is aggregated together with the Sensing Measurement Report frame (e.g., as an A-MPDU). In some cases, the separate frame may be a Sensing Measurement Request frame, a Sensing Measurement Response frame, or a Sensing Measurement Termination frame. When the Sensing Measurement Termination frame is used, similar to methods discussed above, the frame may include the critical update as an element or sub-element and one of the (previously) reserved bits can be used to indicate that the intention of the frame is to update the current session instead of terminating it.

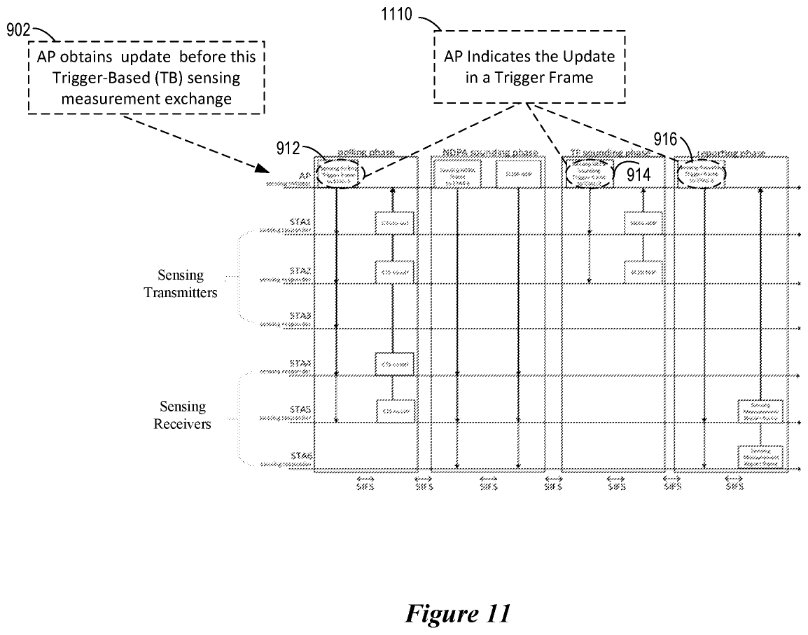

As illustrated in FIG. 11, according to a third option, an existing session may be updated before a measurement session exchange. As illustrated at 1110, rather than provide a notification that the update occurred in a TF and subsequently provide the update separately (as in the example shown in FIG. 9), in the example illustrated in FIG. 11, the update is actually provided in TF. Thus, there may be no need for the unassociated STA to separately retrieve the update.

The AP may indicate, in any of the TFs (912, 914, 916) the latest parameter(s) of the critical update (such as the updated TPE). An advantage of this approach is that it may allow the STAs to adopt the parameters and send responding frames (e.g. CTS-to-self, SR2SI NDP, Report) based on the latest parameters within the current sequence.

In some cases, the TF can indicate the parameters associated with the critical update using reserved bits in a Common Info field, bits in a unique User Info field which is identified by a unique AID (so that the parameters apply to all receiving STAs), or reserved bits in a User Info field destined for a particular STA (e.g., so that the parameters apply that STA only). This may be useful, for example, if other STAs are all associated STAs and have already learned of the critical update from Beacon frames.

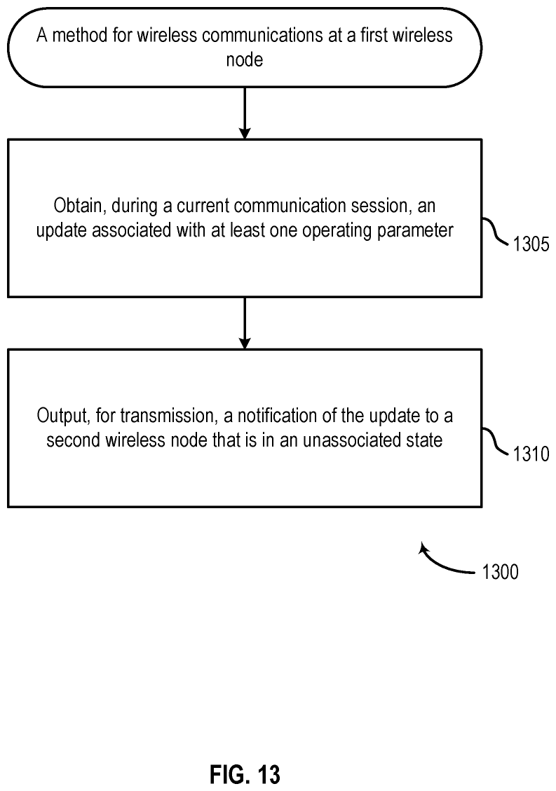

As illustrated in the timing diagram 1300 of FIG. 13, for a non-TB sensing measurement exchange, an AP may send an indication frame 1210 with a (critical). In response, an unassociated STA (STA 1) may respond with an ACK frame 1220.

The indication frame 1210 and corresponding ACK 1220 may be sent at the beginning of a time window for measurement sounding phase, so that an unassociated STA can update its parameters and send future frames (e.g., Sensing NDPA and SI2SR NDP frames) based on the updated parameters.

There are various options for the indication frame. According to a first option, the indication frame may be a Sensing Measurement Request frame, a Sensing Measurement Response frame or a Sensing Measurement Termination frame extended to include the parameters associated with the critical update. According to a second option, the indication frame may be a newly defined compact frame (to reduce overhead).

Such a newly defined compact frame may indicate the update in various manners. For example, the compact frame may carry (an indication of) the update as a single bit (e.g., to request the STA to retrieve the latest parameters from the AP). In some cases, the compact frame may include a bitmap to indicate which parameter(s) have been updated. This may help a STA to decide whether to cancel pending NDPA/NDP frames. For example, if the update is only a spatial stream (SS) change, the STA may transmit with 1SS (most conservative assumption) before retrieving the update. In some cases, the compact frame may include the updated parameters, such as the latest SS or TPE. In some cases, a compact frame may include a combination of these approaches, for example, including a bitmap indicating the parameters that have been updated, as well as the associated updates.

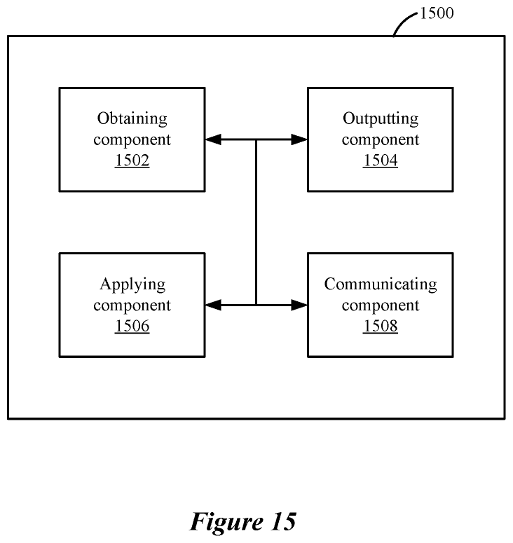

FIG. 13 shows a flowchart illustrating an example process 1300 performable by or at a wireless node (e.g., an access point) that supports a mechanism for signaling updates to an unassociated station. For example, the process 1300 may be performed by a wireless communication device, such as the wireless communication device 1500 described with reference to FIG. 15, operating as or within a wireless AP or STA. In some examples, the process 1300 may be performed by a wireless AP, such as one of the wireless APs 102 described with reference to FIG. 1. In some examples, the process 1300 may be performed by a STA, such as one of the STAs 104 described with reference to FIG. 1.

Method 1300 begins at step 1305 with obtaining, during a current communication session, an update associated with at least one parameter.

Method 1300 then proceeds to step 1310 with outputting, for transmission, a notification of the update to a second wireless node that is in an unassociated state.

In some aspects, the update comprises at least one of: a transmit power envelope (TPE) update or a spatial stream change.

In some aspects, the notification is output for transmission during a sensing measurement exchange sequence.

In some aspects, the notification is output for transmission via a trigger frame.

In some aspects, the notification is output for transmission via one or more bits of at least one of: a common information field of the trigger frame, a user information field of the trigger frame, a trigger dependent field of the trigger frame, or a basic service set (BSS) parameter change count field of the trigger frame.

In some aspects, the method 1300 further includes outputting, for transmission, the update via at least one of a beacon frame or a probe response frame.

In some aspects, the method 1300 further includes obtaining a query frame.

In some aspects, the method 1300 further includes outputting, for transmission, the update via a response frame after obtaining the query frame.

In some aspects, at least one of: the query frame comprises a sensing measurement query frame; or the response frame comprises a sensing measurement request frame, a sensing measurement response frame, or a sensing measurement termination frame.

In some aspects, the sensing measurement termination frame includes at least one bit to indicate the frame carries the update.

In some aspects, the method 1300 further includes outputting, for transmission, the update via at least one of a sensing measurement report frame or a separate frame that is aggregated with the sensing measurement report frame.

In some aspects, the notification is output for transmission via a message that triggers termination of the current communication session.

In some aspects, the method 1300 further includes outputting, for transmission, the update during reestablishment of the communication session.

In some aspects, the update is output for transmission via at least one of a sensing measurement request frame or a sensing measurement response frame.

In some aspects, the notification is output for transmission via a frame at a beginning of a sensing measurement exchange sequence.

In some aspects, at least one of: the frame comprises a trigger frame, a sensing measurement request frame, a sensing measurement response frame, a sensing measurement termination frame, or another type of frame; or the frame also includes the update.

In some aspects, the frame further includes at least one of: a bit indicating the second wireless node is to retrieve the update to the at least one parameter; a bitmap indicating the at least one parameter that has the update; or the update.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

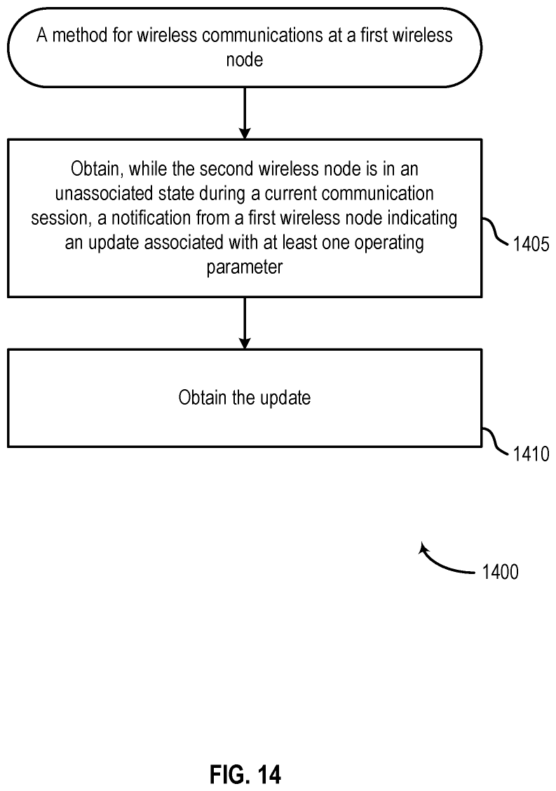

FIG. 14 shows a flowchart illustrating an example process 1400 performable by or at a wireless node (e.g., a wireless station) that supports a mechanism for signaling updates to an unassociated station. For example, the process 1400 may be performed by a wireless communication device, such as the wireless communication device 1500 described with reference to FIG. 15, operating as or within a wireless AP or STA. In some examples, the process 1400 may be performed by a wireless AP, such as one of the wireless APs 102 described with reference to FIG. 1. In some examples, the process 1400 may be performed by a STA, such as one of the STAs 104 described with reference to FIG. 1.

Method 1400 begins at step 1405 with obtaining, while the second wireless node is in an unassociated state during a current communication session, a notification from a first wireless node indicating an update associated with at least one parameter.

Method 1400 then proceeds to step 1410 with obtaining the update.

In some aspects, the update comprises at least one of: a transmit power envelope (TPE) update or a spatial stream change.

In some aspects, the notification is obtained during a sensing measurement exchange sequence.

In some aspects, the notification is obtained via a trigger frame.

In some aspects, the notification is obtained via one or more bits of at least one of: a common information field of the trigger frame, a user information field of the trigger frame, a trigger dependent field of the trigger frame, or a basic service set (BSS) parameter change count field of the trigger frame.

In some aspects, the update is obtained via at least one of a beacon frame or a probe response frame.

In some aspects, the method 1400 further includes outputting, for transmission, a query frame, wherein the update is obtained via a response frame after outputting the query frame for transmission.

In some aspects, at least one of: the query frame comprises a sensing measurement query frame; or the response frame comprises a sensing measurement request frame, a sensing measurement response frame, or a sensing measurement termination frame.

In some aspects, the sensing measurement termination frame includes at least one bit to indicate the frame carries the update.

In some aspects, the update is obtained via at least one of a sensing measurement report frame or a separate frame that is aggregated with the sensing measurement report frame.

In some aspects, the notification is obtained via a message that triggers termination of the current communication session.

In some aspects, the update is obtained during reestablishment of the communication session.

In some aspects, the update is obtained via at least one of a sensing measurement request frame or a sensing measurement response frame.

In some aspects, the notification is obtained via a frame at a beginning of a sensing measurement exchange sequence.

In some aspects, at least one of: the frame comprises a trigger frame, a sensing measurement request frame, a sensing measurement response frame, a sensing measurement termination frame, or another type of frame; or the update is also obtained from the frame.

In some aspects, the frame further includes at least one of: a bit indicating the second wireless node is to retrieve the update to the at least one parameter; a bitmap indicating the at least one parameter that has the update; or the update.

In one aspect, method 1400, or any aspect related to it, may be performed by an apparatus, such as communications device 1500 of FIG. 15, which includes various components operable, configured, or adapted to perform the method 1400. Communications device 1500 is described below in further detail.

Note that FIG. 14 is just one example of a method, and other methods including fewer, additional, or alternative steps are possible consistent with this disclosure.

FIG. 15 shows a block diagram of an example wireless communication device 1500 that supports a mechanism for signaling updates to an unassociated station. In one example, the wireless communication device 1500 is configured or operable to perform a process 1300, and/or 1400 described with reference to FIGS. 13 and 14 respectively. In various examples, the wireless communication device 1500 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 1500 can be a device for use in an AP, such as AP 102 described with reference to FIG. 1. In some examples, the wireless communication device 1500 can be a device for use in a STA, such as STA 104 described with reference to FIG. 1. In some other examples, the wireless communication device 1500 can be an AP or a STA that includes such a chip, SoC, chipset, package or device as well as multiple antennas. The wireless communication device 1500 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 1500 also includes or can be coupled with an application processor which may be further coupled with another memory. In some examples, the wireless communication device 1500 further includes at least one external network interface that enables communication with a core network or backhaul network to gain access to external networks including the Internet.

The wireless communication device 1500 includes at least an obtaining component 1502, an outputting component 1504, an applying component 1506, and a communicating component 1508. Portions of one or more of the components 1502, 1504, 1506 and/or 1508 may be implemented at least in part in hardware or firmware. For example, the obtaining component 1502 may be implemented at least in part by a modem. In some examples, at least some of the components 1502, 1504, 1506 and/or 1508 are implemented at least in part by a processor and as software stored in a memory. For example, portions of one or more of the components 1502, 1504, 1506 and/or 1508 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 1500). For example, a processing system of the wireless communication device 1500 may refer to a system including the various other components or subcomponents of the wireless communication device 1500, such as the processor, or a transceiver, or a communications manager, or other components or combinations of components of the wireless communication device 1500. The processing system of the wireless communication device 1500 may interface with other components of the wireless communication device 1500, and may process information received from other components (such as inputs or signals) or output information to other components. For example, a chip or modem of the wireless communication device 1500 may include a processing system, a first interface to output information and a second interface to obtain information. In some implementations, the first interface may refer to an interface between the processing system of the chip or modem and a transmitter, such that the wireless communication device 1500 may transmit information output from the chip or modem. In some implementations, the second interface may refer to an interface between the processing system of the chip or modem and a receiver, such that the wireless communication device 1500 may obtain information or signal inputs, and the information may be passed to the processing system. A person having ordinary skill in the art will readily recognize that the first interface also may obtain information or signal inputs, and the second interface also may output information or signal outputs.

### EXAMPLE CLAUSES

Implementation examples are described in the following numbered clauses:

Clause 1: A method of wireless communications at a first wireless node, comprising: obtaining, during a current communication session, an update associated with at least one parameter; and outputting, for transmission, a notification of the update to a second wireless node that is in an unassociated state.

Clause 2: The method of Clause 1, wherein the update comprises at least one of: a transmit power envelope (TPE) update or a spatial stream change.

Clause 3: The method of any one of Clauses 1-2, wherein the notification is output for transmission during a sensing measurement exchange sequence.

Clause 4: The method of any one of Clauses 1-3, wherein the notification is output for transmission via a trigger frame.

Clause 5: The method of Clause 4, wherein the notification is output for transmission via one or more bits of at least one of: a common information field of the trigger frame, a user information field of the trigger frame, a trigger dependent field of the trigger frame, or a basic service set (BSS) parameter change count field of the trigger frame.

Clause 6: The method of Clause 4, further comprising outputting, for transmission, the update via at least one of a beacon frame or a probe response frame.

Clause 7: The method of any one of Clauses 1-6, further comprising: obtaining a query frame; and outputting, for transmission, the update via a response frame after obtaining the query frame.

Clause 8: The method of Clause 7, wherein at least one of: the query frame comprises a sensing measurement query frame; or the response frame comprises a sensing measurement request frame, a sensing measurement response frame, or a sensing measurement termination frame.

Clause 9: The method of Clause 8, wherein the sensing measurement termination frame includes at least one bit to indicate the frame carries the update.

Clause 10: The method of any one of Clauses 1-9, further comprising outputting, for transmission, the update via at least one of a sensing measurement report frame or a separate frame that is aggregated with the sensing measurement report frame.

Clause 11: The method of any one of Clauses 1-10, wherein: the notification is output for transmission via a message that triggers termination of the current communication session.

Clause 12: The method of Clause 11, further comprising outputting, for transmission, the update during reestablishment of the communication session.

Clause 13: The method of Clause 12, wherein the update is output for transmission via at least one of a sensing measurement request frame or a sensing measurement response frame.

Clause 14: The method of any one of Clauses 1-13, wherein the notification is output for transmission via a frame at a beginning of a sensing measurement exchange sequence.

Clause 15: The method of Clause 14, wherein at least one of: the frame comprises a trigger frame, a sensing measurement request frame, a sensing measurement response frame, a sensing measurement termination frame, or another type of frame; or the frame also includes the update.

Clause 16: The method of Clause 14, wherein the frame further includes at least one of: a bit indicating the second wireless node is to retrieve the update to the at least one parameter; a bitmap indicating the at least one parameter that has the update; or the update.

Clause 17: A method of wireless communications at a second wireless node, comprising: obtaining, while the second wireless node is in an unassociated state during a current communication session, a notification from a first wireless node indicating an update associated with at least one parameter; and obtaining the update.

Clause 18: The method of Clause 17, wherein the update comprises at least one of: a transmit power envelope (TPE) update or a spatial stream change.

Clause 19: The method of any one of Clauses 17-18, wherein the notification is obtained during a sensing measurement exchange sequence.

Clause 20: The method of any one of Clauses 17-19, wherein the notification is obtained via a trigger frame.

Clause 21: The method of Clause 20, wherein the notification is obtained via one or more bits of at least one of: a common information field of the trigger frame, a user information field of the trigger frame, a trigger dependent field of the trigger frame, or a basic service set (BSS) parameter change count field of the trigger frame.

Clause 22: The method of Clause 20, wherein the update is obtained via at least one of a beacon frame or a probe response frame.

Clause 23: The method of any one of Clauses 17-22, further comprising: outputting, for transmission, a query frame, wherein the update is obtained via a response frame after outputting the query frame for transmission.

Clause 24: The method of Clause 23, wherein at least one of: the query frame comprises a sensing measurement query frame; or the response frame comprises a sensing measurement request frame, a sensing measurement response frame, or a sensing measurement termination frame.

Clause 25: The method of Clause 24, wherein the sensing measurement termination frame includes at least one bit to indicate the frame carries the update.

Clause 26: The method of any one of Clauses 17-25, wherein the update is obtained via at least one of a sensing measurement report frame or a separate frame that is aggregated with the sensing measurement report frame.

Clause 27: The method of any one of Clauses 17-26, wherein: the notification is obtained via a message that triggers termination of the current communication session.

Clause 28: The method of Clause 27, wherein the update is obtained during reestablishment of the communication session.

Clause 29: The method of Clause 28, wherein the update is obtained via at least one of a sensing measurement request frame or a sensing measurement response frame.

Clause 30: The method of any one of Clauses 17-29, wherein the notification is obtained via a frame at a beginning of a sensing measurement exchange sequence.

Clause 31: The method of Clause 30, wherein at least one of: the frame comprises a trigger frame, a sensing measurement request frame, a sensing measurement response frame, a sensing measurement termination frame, or another type of frame; or the update is also obtained from the frame.

Clause 32: The method of Clause 30, wherein the frame further includes at least one of: a bit indicating the second wireless node is to retrieve the update to the at least one parameter; a bitmap indicating the at least one parameter that has the update; or the update.

Clause 33: An apparatus, comprising: a memory comprising executable instructions; and a processor configured to execute the executable instructions and cause the apparatus to perform a method in accordance with any one of Clauses 1-32.

Clause 34: An apparatus, comprising means for performing a method in accordance with any one of Clauses 1-32.

Clause 35: A non-transitory computer-readable medium comprising executable instructions that, when executed by a processor of an apparatus, cause the apparatus to perform a method in accordance with any one of Clauses 1-32.

Clause 36: A computer program product embodied on a computer-readable storage medium comprising code for performing a method in accordance with any one of Clauses 1-32.

Clause 37: An access point (AP) comprising at least one transceiver; at least one memory comprising executable instructions; and at least one processor configured to execute the executable instructions and cause the AP to perform a method in accordance with any one of Clauses 1-16, wherein the at least one transceiver is configured to transmit the notification.

Clause 38: A wireless station comprising at least one transceiver; at least one memory comprising executable instructions; and at least one processor configured to execute the executable instructions and cause the wireless station to perform a method in accordance with any one of Clauses 17-32, wherein the at least one transceiver is configured to receive the notification and receive the update.

### Additional Considerations

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

Means for obtaining, means for outputting, means for applying, and means for communicating may comprise one or more processors, such as one or more of the processors or components described above with reference to FIG. 15.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communications, comprising:
at least one memory comprising computer-executable instructions; and
one or more processors configured to execute the computer-executable instructions and cause the apparatus to:
obtain, at a first wireless node during a current communication session, an update associated with at least one parameter; and
output, for transmission, a notification of the update to a second wireless node that is in an unassociated state.

2. The apparatus of claim 1, wherein the update comprises at least one of: a transmit power envelope (TPE) update or a spatial stream change.

3. The apparatus of claim 1, wherein the notification is output for transmission during a sensing measurement exchange sequence.

4. The apparatus of claim 1, wherein the notification is output for transmission via a trigger frame.

5. The apparatus of claim 4, wherein the notification is output for transmission via one or more bits of at least one of: a common information field of the trigger frame, a user information field of the trigger frame, a trigger dependent field of the trigger frame, or a basic service set (BSS) parameter change count field of the trigger frame.

6. The apparatus of claim 4, wherein the one or more processors are further configured to cause the apparatus to:
output, for transmission, the update via at least one of a beacon frame or a probe response frame.

7. The apparatus of claim 1, wherein the one or more processors are further configured to cause the apparatus to:
obtain a query frame; and
output, for transmission, the update via a response frame after obtaining the query frame.

8. The apparatus of claim 7, wherein at least one of:
the query frame comprises a sensing measurement query frame; or
the response frame comprises a sensing measurement request frame, a sensing measurement response frame, or a sensing measurement termination frame.

9. The apparatus of claim 8, wherein the sensing measurement termination frame includes at least one bit to indicate the sensing measurement termination frame carries the update.

10. The apparatus of claim 1, wherein the one or more processors are further configured to cause the apparatus to output, for transmission, the update via at least one of a sensing measurement report frame or a separate frame that is aggregated with the sensing measurement report frame.

11. The apparatus of claim 1, wherein:
the notification is output for transmission via a message that triggers termination of the current communication session.

12. The apparatus of claim 11, wherein the one or more processors are further configured to cause the apparatus to output, for transmission, the update during reestablishment of the current communication session.

13. The apparatus of claim 12, wherein the update is output for transmission via at least one of a sensing measurement request frame or a sensing measurement response frame.

14. The apparatus of claim 1, further comprising at least one transceiver configured to transmit the notification, wherein the apparatus is configured as an access point (AP).

15. An apparatus for wireless communications, comprising:
at least one memory comprising computer-executable instructions; and
one or more processors configured to execute the computer-executable instructions and cause the apparatus to:
obtain, at a second wireless node while the second wireless node is in an unassociated state during a current communication session, a notification from a first wireless node indicating an update associated with at least one parameter; and
obtain the update.

16. The apparatus of claim 15, wherein the update comprises at least one of: a transmit power envelope (TPE) update or a spatial stream change.

17. The apparatus of claim 15, wherein the notification is obtained during a sensing measurement exchange sequence.

18. The apparatus of claim 15, wherein the notification is obtained via a trigger frame.

19. The apparatus of claim 18, wherein the notification is obtained via one or more bits of at least one of: a common information field of the trigger frame, a user information field of the trigger frame, a trigger dependent field of the trigger frame, or a basic service set (BSS) parameter change count field of the trigger frame.

20. The apparatus of claim 18, wherein the update is obtained via at least one of a beacon frame or a probe response frame.

21. The apparatus of claim 15, wherein the one or more processors are further configured to cause the apparatus to:
output, for transmission, a query frame, wherein the update is obtained via a response frame after outputting the query frame for transmission.

22. The apparatus of claim 21, wherein at least one of:
the query frame comprises a sensing measurement query frame; or
the response frame comprises a sensing measurement request frame, a sensing measurement response frame, or a sensing measurement termination frame.

23. The apparatus of claim 22, wherein the sensing measurement termination frame includes at least one bit to indicate the sensing measurement termination frame carries the update.

24. The apparatus of claim 15, wherein the update is obtained via at least one of a sensing measurement report frame or a separate frame that is aggregated with the sensing measurement report frame.

25. The apparatus of claim 15, wherein:
the notification is obtained via a message that triggers termination of the current communication session.

26. The apparatus of claim 25, wherein the update is obtained during reestablishment of the current communication session.

27. The apparatus of claim 26, wherein the update is obtained via at least one of a sensing measurement request frame or a sensing measurement response frame.

28. The apparatus of claim 15, wherein the notification is obtained via a frame at a beginning of a sensing measurement exchange sequence.

29. The apparatus of claim 15, further comprising at least one transceiver configured to receive the notification and receive the update, wherein the apparatus is configured as a wireless station.

30. A method of wireless communications at a second wireless node, comprising:
obtaining, while the second wireless node is in an unassociated state during a current communication session, a notification from a first wireless node indicating an update associated with at least one parameter; and
obtaining the update.
